(19) United States
(12) Patent Application Publication
(10) Pub. No.: US 2006/0159900 A1
(43) Pub. Date: Jul. 20, 2006

(54) Adhesive combination and method for making hard surfaces-veneer engineered surfacing tiles

(76) Inventors: Robert J. Miller, Dalton, GA (US); Todd A. Cramer, Ooltewah, TN (US); Wesley E. Cannon, Dalton, GA (US)

Correspondence Address: CAHN & SAMUELS LLP, 2000 P STREET NW, SUITE 200, WASHINGTON, DC, 20036, US

(21) Appl. No.: 11/037,391

(22) Filed: Jan. 19, 2005

(51) Int. Cl. B32B 7/02

(52) U.S. Cl. 428/212

(57) ABSTRACT

A laminated, hard surface veneer panel structure formed of a hard surface veneer adhered to a coreboard with an adhesive layer with a pressure sensitive hot-melt adhesive and a second curable, polyurethane resin first quick setting adhesive having a first binding strength and a second longer setting, curable adhesive having a second bonding strength where the first adhesive promotes lateral dispersion of said second adhesive before said second adhesive cures.

### CROSS-REFERENCE TO RELATED APPLICATION

This application claims the benefit of U.S. Provisional application Ser. No. 60/535,495 with the filing date of Jan. 15, 2004.

### FIELD OF THE INVENTION

This invention relates to improvements in manufacture of engineered, veneer, hard surface tile panels for use in flooring applications. More specifically, this invention relates to specific adhesive applications for establishing a rugged laminated flooring featuring interlockable tiles having a hard surface veneer layer of ceramics, porcelains, marbles, granites or stone adhered with precision to underlying high density fiberboard backing.

### BACKGROUND

One type of flooring that has recently enjoyed a surge in consumer acceptance and commercial success is a laminated, engineered, hard-surface veneer, interlocking, floating, tile units (EDGE RTM flooring tiles produced by Edge Flooring of Dalton, Ga.). Such engineered tile panel structures and methods substitute for conventional ceramic tile/stone/marble/slate slab construction. EDGE flooring tile products overcome problems associated with conventional ceramic/natural stone tile manufacture, handling, shipping and installation. The Edge flooring products embody the teachings contained in U.S. Ser. No. 10/423,881 filed Apr. 28, 2003 invented by Robert J. Miller, the subject matter of which is incorporated by reference in its entirety.

### SUMMARY OF THE INVENTIONS

It is an object of the present invention to provide method for making improved engineered, veneer, hard surface tile panels for use in flooring applications.

It is an object of the present invention to provide a novel adhesive arrangement for securely affixing hard surface veneer to backing panels.

Still another object of the present invention is to provide specific adhesive combinations and methods for engineered, hard surface tile panels for use in flooring applications.

A further object of the present invention is to provide an engineered tile panel formed of a hard surface veneer precisely and durably adhered to a backer board for use in flooring applications.

These and other objects of the invention are satisfied by a laminated, hard surface veneer structure comprising: a veneer; a base; and an adhesive layer, where the adhesive layer is disposed between the base and the veneer and is composed of at least a first quick setting adhesive having a first binding strength and a longer setting, curable adhesive having a second bonding strength greater than the first bonding strength where the first adhesive promotes lateral dispersion of said second adhesive before said second adhesive cures when disposed between said veneer and said base.

Other objects of the invention are satisfied by a structure and method of adhesive application that establishes generally uniform and secure adherence over an entire veneered surface and an underlying backerboard.

The present invention is directed to a combination of a quick drying pressure sensitive/hot melt adhesive for securing a hard surface veneer onto a backerboard and a durable, longer-drying curable resin. The quick drying adhesive serves to fasten/clamp the veneer onto the underlying backer board and to resist separation of the veneer from backer board caused by force generated during curing of the curable resin. By resisting separation, the curable resin expands in a planar/lateral mode rather than a vertical mode. This “out-not-up” expansion enhances processing uniformity and uniformity of finished veneer tiles.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing, and which is shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

Given the following detailed description, it should become apparent to the person having ordinary skill in the art that the invention herein provides a novel engineered tile and method permitting exploitation of significantly augmented efficiencies while mitigating problems of the prior art.

### BRIEF DESCRIPTION OF THE DRAWINGS

FIG. 1 is a cross-sectional view of an engineered tile panel according to one embodiment of the invention.

FIG. 2 is a cross-sectional view of an engineered tile panel according to an alternative exemplary embodiment of the invention.

FIG. 3 is a top view of an adhesive pattern for affixing the veneer to an underlying backerboard in accordance with the invention.

### DESCRIPTION OF THE ILLUSTRATED EMBODIMENT

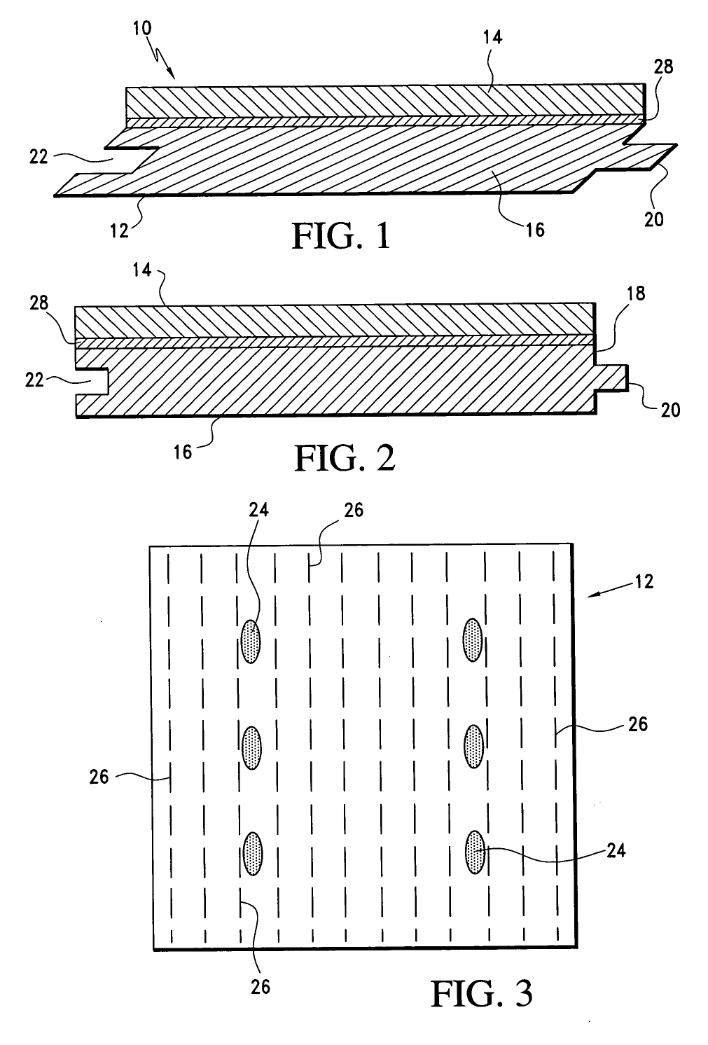

Referring now to the detailed drawings, in which like reference numerals indicate like parts throughout the multiple views, a preferred embodiment of an engineered tile panel of the invention are illustrated in FIGS. 1 and 2. The hard surface, veneered tile panel 10 is a unitary, laminated, planar member that does not require secondary reinforcement material backing.

The tile panel 10, in the illustrated embodiment has a ligneous coreboard/backerboard 12 which includes a tongue profile 20 projecting medially between the upper veneer surface 14 and the lower planar surface 16 of the coreboard along the edge 18 of the coreboard 12. The tongue profile may be discontinuous but preferably is coextensive with the edge 18. A groove 22 is disposed along the opposite edge 24 and is dimensioned to receive and interlock with the tongue profile 20. Preferably the interlocking tongue and groove embody the UniclicRTM profiles such as those disclosed and described in U.S. Pat. Nos. 6,006,486 and 6,490,836, (Moriau et al/Unilin Beeher BV). However, any profile or even a generic tongue and groove may be employed. The coreboard thickness ranges from 4 to 12 mm so that the laminated panel tile 10 conforms in thickness to conventional ceramic and stone tile thickness.

The coreboard/backerboard 12 typically is composed from a processed wood or paper material. A preferred coreboard material is 6.8 mm HDF (High density Fiberboard), HD850 Panfibre or equivalent, complying with ANSI A208.2-94 Grade HD which exhibits appropriate resistance to bending or bowing suitable for most flooring applications. This preferred high density, ligneous coreboard has a width of 306.4 mm/12.0625 in and a length of 612.8 mm/24.1248 in to accommodate placement of two tile veneers and a depth of 7.6 mm/0.299 in. The coreboard possesses moisture content of approximately 5.5%±1% and a density of approximately 870 Kg/m providing a coreboard weight of 1.2700586 kg/2.8 lb.

The natural stone or ceramic veneer 14 is formed in squares measuring 304.8 mm×304.8 mm12×12 inches with a depth of 6.0 mm/0.236 in. The veneer thickness preferably is about 8 mm. By practice of the present invention, a pair of veneer squares is precisely placed and affixed to the underlying coreboard 12 so as to be recessed by a pre-established, uniform 0.0125 inch (3.17 mm) grouting gaps between adjacent tiles. The veneers may be beveled, preferably about 1 mm, along the upper peripheral edges to provide for a generally smooth, uniform finish. To enhance uniform distribution of the below described adhesive combination, the lower face of the veneer may include a profile or pattern promoting uniform distribution of bonding adhesives. The final weight of a bonded, engineered tile is approximately 4.4 lb/sq. ft (0.185 kg/m²) per tile.

Moving now to the bonding/adhesion technique of this invention, it contemplates veneer pick and placement onto a coreboard with a pre-formed grid/pattern of adhesives deposited thereon as illustrated in FIG. 3. The adhesives contemplated by the invention are a combination of a fast drying, pressure activated adhesive 24 with a stronger but longer drying, curable bonding composition 26. As part of the pick and placement of the veneer onto the coreboard having the adhesives already distributed on the coreboard, pressure should be applied to the veneer sufficient to activate bonding of the fast drying, pressure activated adhesive. The illustrated embodiment describes a combination of quick setting, hot-melt/pressure sensitive adhesive 24 with a stronger, more permanent, somewhat resilient, curable polyurethane resin (“PUR”) 26.

As illustrated, the adhesive and PUR are deposited in a specific pattern on the core board so as to receive, securely position, and retain the veneer on the coreboard. The adhesive, mechanically analogous to a clamp, urges the PUR, during curing, to spread laterally rather than vertically. Thus, the combination of adhesives minimizes separation of the veneer from the coreboard and introduction of non-uniformities into the finished laminated veneer products. In the preferred application, the gluing pattern deposits the two adhesives on the coreboard so as to induce an effectively uniform lamination morphology not only across an entire finished product but also an entire production run.

Referring to the adhesive deposition pattern in FIG. 3, the adhesive is extruded under pressure onto the upper surface of the coreboard 12. Following placement of the veneer onto the coreboard, the adhesive combination of the invention establishes a thin, water impervious adhesive layer 28 typically ranging from 0.05 to 0.75 mm in thickness but preferably about 0.2 mm.

The quick-setting pressure sensitive adhesive contemplated for use in this invention is preferably a pressure sensitive, hot melt resin that provides a reliable but temporary bond between the coreboard and the overlying veneer. The pressure sensitive adhesive is applied within discrete, selected zones distributed on the surface of the coreboard well within the interior of the coreboard and veneer edges. The quick setting adhesive serves two principle functions. First, it affixes the veneer to the coreborad allowing for sufficient time for the longer-drying, bonding resin (preferably polyurethane) to cure. The second function is to clamp/retain the veneer against the coreboard, distributing the longer-drying resin laterally. In the absence of the quick drying adhesive, during the curing period, the more permanent, PUR resin has been observed to physically expand to induce vertical displacement of the veneer. Thus, the use of the quick drying adhesive prevents separation of the veneer from the coreboard. The combination of short cure time and longer cure time resins insures veneer uniformity throughout the production process as well as under rigorous ambient use typical of flooring products.

A preferred pressure sensitive, hot melt adhesive is a resin based thermoplastic with the performance and physical characteristics approximating that of SWIFT 28776 available from Forbo Adhesives, LLC of Triangle Park, N.C. The hot melt adhesive is applied using a Nordson Triple 0.018 nozzle to provide a set of six 32 mm long oval dollops, in two rows of three. The dollops define the outline of a discontinuous rectangle with the four corner dollops set approximately 73 mm from the coreboard edges and the two middle dollops set respectively at 73 mm from the inside and outside edges and 150 mm from the front and back edges. Other compositions meeting the general objectives for the pressure sensitive adhesive contemplated for this invention can be used such as a vinyl acteate/vinyl copolymer mixture (Swift 2H862) and/or a polymer, tackifying resin polyethylene based composition (Swift 85015), again available from Forbo Adhesives.

The principal adhesive for permanent bonding of the veneer to the coreboard is the above-mentioned polyurethane resin. The PUR, preferably, is EVER-LOCK 3U011 from Forbo Adhesives or its equivalent. Ever-Lock 3u011 is a fast bonding strong adhesive capable of achieving a tensile strength in excess of 400 lbf which in part is attributable to its ability to penetrate and/or dissolve powder residue occurring in natural stone. Thus, it is ideally suited for bonding natural stone, marble, porcelains and/or ceramics to wood/ligneous solid or composite materials fiber wood or wood core backings. It generally comprises an MDI, methylene diphenyl diisocyanate, combined less than 9% VOC (volatile organics) and desirably, is non-flammable. The EVER-LOCK 3U011 has a boiling point of greater than 149° C./300° F., a freezing point of less than 0° C./32° F. and a specific Gravity of 1.15 @ ambient (26.25° C./79° F.). The cure time for EVER-LOCK 3U011 is between 32-48 minutes after which, it possesses tensile strength in excess of 400 lbf ASTM C648 and maintains its adhesive properties over a broad temperature range, e.g., −29° C./−20° F. to 71° C./160° F.

The EVER-LOCK 3U011 PUR is applied directly to the upper surface of the coreboard in the form of rows. The PUR beads are approximately 25 mm in length and are substantially uniformly spaced and linearly discontinuous preferably to establish a regularly spaced grid within the boundaries of the veneer. Automated application is preferred for dispensing approximately 20 grams of PUR per square foot of coreboard using, for example, preset Oest 1.5 mm nozzles (The Oest GmbH & Co. Maschinenbau KG of Freudenstadt, Germany). As illustrated in FIG. 3, the first row of beads form a discontinuous line of the curable resin where each bead is linearly separated by 7 mm. The layer 26 is applied to the top of the panel to create a surface bond of at least 60% coverage between the core 12 and veneer 28. The row of beads located proximate to the outside edge of the coreboard, corresponding to and overlying the groove, is recessed and parallelly disposed approximately 14 mm from that edge. Each of the twelve bead rows is spaced from the adjacent bead row by approximately 25 mm and the terminal beads are inset 7 mm from the upper and lower coreboard edges. The beads in a given row are separated by approximate 7 mm. The line closest to the tongue side edge portion of the coreboard is recessed from the coreboard edge by 12 mm.

The PUR preferably possesses some flexibility to reduce risk of loss, particularly during transport and or handling damage to the finished veneer and or the bond of the finished veneer to the core. Compensating for some movement is also preferred to minimize damage associated with natural movement and substructure movement or deflection inherent in most building materials and design structures. In addition to possessing water resistance, PUR glue or adhesive should exhibit some elasticity/flexibility to allow the substrate panel to independently change in dimension or twist and or bend greater than 2 mm per lineal foot without severing or causing failure to the bond between the veneer and the panel.

Although described in the context of a ligneous backerboard, the invention is not intended to be so limited. An alternative backboard could be constructed from molded resin and the like. Furthermore, alternative bi-component adhesive combinations can be used subject to providing substantially similar performance characteristics described above.

From the foregoing, it should be readily appreciated that the inventive tiles/panels resulting from the use of this invention are sturdier and lighter than sheets of stone or ordinary tile. Moreover, due to the overall more rugged nature of the laminated products, the risk of damage is lessened.

Although the embodiments of the invention are disclosed in the forgoing specification, it is understood by those skilled in the art that many other modifications and embodiments of the invention will come to mind to which the invention pertains, having benefit of the teaching presented in the foregoing description and associated drawings. It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

We claim:

1. A laminated, hard surface veneer panel structure comprising:
a veneer;
a base; and
an adhesive layer, where the adhesive layer is disposed between the base and the veneer and is composed of at least a first quick setting adhesive having a first binding strength and a second longer setting, curable adhesive having a second bonding strength where the first adhesive promotes lateral dispersion of said second adhesive before said second adhesive cures.

2. The laminated, hard surface veneer panel of claim 1 where the second bonding strength is greater than the first bonding strength once cured.

3. The laminated, hard surface veneer panel of claim 1 where the second adhesive is a polyurethane resin.

4. The laminated, hard surface veneer panel of claim 3 where the first adhesive is a pressure sensitive hot melt adhesive.

5. The laminated, hard surface veneer panel of claim 3 where the base is a ligneous backerboard defining a rectangle sized to receive two veneers and having upper, lower, and side edges, one side edge defining a tongue.

6. The laminated, hard surface veneer panel of claim 5 where the first adhesive is deposited in six space locations on the base in equal amounts and serves to promote lateral dispersion of the second adhesive during time for curing.

7. The laminated, hard surface veneer panel of claim 6 where separation of the veneer from the base during curing of the second adhesive is minimized.

8. The laminated, hard surface veneer panel of claim 7 where the pressure sensitive, hot melt adhesive is selected from the group consisting of a vinyl acteate/vinyl copolymer mixture and a tackifying polyethylene resin.

9. The laminated, hard surface veneer panel of claim 8 where the cured adhesives form a moisture impervious layer of between 0.05 to 0.75 mm.

10. The laminated, hard surface veneer panel of claim 9 where the cured adhesive exhibits a substantially uniform morphology across the entire veneered surface and has a thickness of 0.2 mm.

11. The method of forming laminated, hard surface veneer panel according to claim 1 including the step of applying the second adhesive to base in rows of spaced discrete beads to achieve at least 60% coverage between the base and the veneer.

12. The method of claim 11 further comprising the step of forming rows of approximately 25 mm beads separated by approximately 7 mm and spacing the rows apart by approximately 25 mm.

13. The method of claim 12 further comprising the step of spacing the terminal beads approximately 7 mm from the upper and lower base edges and 12 mm from the tongued base edge.

14. A laminated, hard surface veneer panel structure comprising:
a hard surface veneer sections;
a ligneous backerboard sized to receive a pair of veneer sections; and
an adhesive layer disposed between the backerboard and the veneer sections composed of a plurality of discreet dollops of first pressure sensitive, hot melt adhesive and a plurality of evenly spaced rows of beads of a second curable polyurethane resin adhesive where the first adhesive promotes lateral dispersion of said second adhesive before said second adhesive cures to a cured thickness of 0.2 mm with a substantially uniform morphology across the entire veneered sections.

15. A method of adhering a hard surface veneer to a ligneous coreboard, comprising the steps of:
applying a first quick setting hot melt adhesive at discrete locations on the ligneous coreboard;
applying a second permanent curable adhesive on the ligneous coreboard in locations other than the discrete locations;
placing the hard surface veneer onto the coreboard over the first and second adhesives;
applying pressure to the veneer to affix the veneer to the coreboard with the first adhesive;
promoting lateral dispersion of the second adhesive; and
providing sufficient time for the second adhesive to cure and adhere the veneer to the coreboard.

16. The method according to claim 15 further comprising the step of forming rows of uniformly spaced, discrete beads.

17. The method according to claim 15 further comprising the step of forming the rows separated by approximately 25 mm.
